(19) United States
(12) Patent Application Publication
(10) Pub. No.: US 2020/0182245 A1
(43) Pub. Date: Jun. 11, 2020

(54) ELECTRIC OIL PUMP

(71) Applicant: Nidec Tosok Corporation, Zama-shi, Kanagawa (JP)

(72) Inventors: Shigehiro KATAOKA, Zama-shi (JP); Yoshiyuki KOBAYASHI, Zama-shi (JP)

(21) Appl. No.: 16/632,580

(22) PCT Filed: Aug. 16, 2018
(86) PCT No.: PCT/JP2018/030419

§ 371 Date: Jan. 21, 2020

(30) Foreign Application Priority Data
Aug. 31, 2017 (JP) 2017-167937

(51) Int. Cl. F04C 29/02; H02K 5/22; H02K 5/24; H02K 7/14; H02K 11/33; H02K 21/16; F04C 15/00

(52) U.S. Cl. CPC F04C 29/02; H02K 5/225; H02K 5/24; H02K 7/14; H02K 11/33; F04C 2240/60; F04C 15/00; H02K 2211/03; F04C 2240/30; F04C 2240/20; F04C 2240/10; H02K 21/16

(57) ABSTRACT

An electric oil pump includes a motor including a shaft, a pump on a front side of the motor and driven by the shaft, and an inverter fixed to a rear side of the motor. The motor includes a rotor, a stator, and a motor housing. The pump includes a pump housing. The inverter includes an inverter housing in which a circuit board is housed, and an inverter housing connector that fixes the inverter housing to the motor housing. The pump includes a pump fixing connector, and the circuit board includes an electronic component mounted on the circuit board adjacent to the motor part, and overlaps the inverter housing fixing connector in a direction perpendicular or substantially perpendicular to an axial direction.

### CROSS REFERENCE TO RELATED APPLICATIONS

This is a U.S. national stage of PCT Application No. PCT/JP2018/030419, filed on Aug. 16, 2018, and claiming priority under 35 U.S.C. § 119(a) and 35 U.S.C. § 365(b) to Japanese Application No. 2017-167937, filed Aug. 31, 2017, the entire disclosures of these applications being herein incorporated herein by reference.

### FIELD OF THE INVENTION

The present disclosure relates to an electric oil pump.

### BACKGROUND

For example, an electric oil pump in which an inverter part having a circuit board and an electric pump are integrated is disclosed in Japanese Unexamined Patent Application Publication No. 2013-092126. The electric oil pump has an oil pump portion and an inverter part. The electric oil pump is housed and fixed in a pump housing hole provided in a housing of a gearbox. To be more specific, the oil pump portion is inserted into the pump housing hole, and the inverter part is disposed adjacent to a motor portion of the oil pump portion and extends in a direction along an outer surface of the housing of the gearbox. The oil pump portion and the inverter part are fixed to the housing of the gearbox via bolts.

The electric oil pump described in Japanese Unexamined Patent Application Publication No. 2013-092126, is fixed inside the gearbox, but the electric oil pump may be fixed outside the gearbox. If the electric oil pump is fixed outside the gearbox, the inverter part is brought into a cantilever support state with respect to a position at which the electric oil pump is fixed to the gearbox. For this reason, if vibrations generated by, for instance, an engine propagate to the electric oil pump via the gearbox, there is a fear that the inverter part at a position apart from the fixed position will greatly vibrate due to the vibrations that have propagated to the electric oil pump. Therefore, there is a fear that a rib of an electronic component (e.g., a capacitor) mounted on a circuit board will be disconnected.

### SUMMARY

Example embodiments of the present disclosure provide electric oil pumps each capable of alleviating the fear that, in a case where the electric oil pump including an inverter is fixed, an electronic component mounted on a circuit board inside the inverter will be damaged due to vibrations.

An illustrative example embodiment of the present application is an electric oil pump that includes a motor including a shaft with a central axis extending in an axial direction, a pump located on one side of the motor in the axial direction, driven via the shaft by the motor, and discharging oil, and an inverter located on another side of the motor in the axial direction and fixed to the motor. The motor includes a rotor that is fixed on a side of the shaft in the axial direction, a stator that is located outside the rotor in a radial direction, and a motor housing that houses the rotor and the stator. The pump includes a pump rotor that is mounted on the shaft protruding from the motor to one side in the axial direction, and a pump housing that includes a housing in which the pump rotor is housed. The inverter includes an inverter housing that includes a circuit board housing in which a circuit board is housed, and an inverter housing connector that fixes the inverter housing to the an end of the motor housing in the axial direction. The pump includes a pump connector to be fixed, and the circuit board includes an electronic component mounted on the circuit board. The electronic component is mounted on the circuit board adjacent to the motor, and the electronic component overlaps the inverter housing connector in a direction perpendicular or substantially perpendicular to the axial direction.

According to the illustrative example embodiment of the present application described above, an electric oil pump is capable of alleviating the fear that, in a case where the electric oil pump including an inverter is fixed, terminals of an electronic component mounted on a circuit board inside the inverter will be damaged due to vibrations.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a sectional view of an electric oil pump according to a first example embodiment of the present disclosure.

FIG. 2 is a sectional view of an inverter housing including an inverter housing connector according to the first example embodiment when viewed from a diagonal front side.

FIG. 3 is a sectional view of an electric oil pump according to a second example embodiment of the present disclosure.

FIG. 4 is a perspective view of a fixing plate when the electric oil pump according to the second example embodiment is viewed from a diagonal front side.

FIG. 5 is an internal structure view of the inverter housing illustrating a position relationship of a capacitor mounted on a circuit board according to the second example embodiment to an electronic component disposing recess.

FIG. 6 is a sectional view of the inverter housing including the electronic component disposing recess according to the second example embodiment.

### DETAILED DESCRIPTION

Hereinafter, an electric oil pump according to example embodiments of the present disclosure will be described with reference to the drawings. Further, in the following drawings, to facilitate understanding each constitution, a scale and number of each structure may differ from an actual structure.

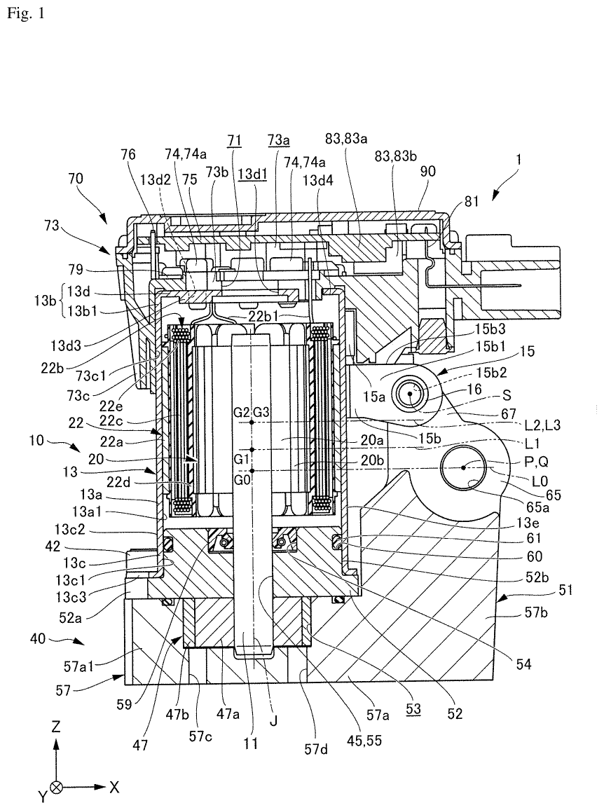

Further, in the drawings, an XYZ coordinate system is appropriately represented as the three-dimensional orthogonal coordinate system. In the XYZ coordinate system, the Z-axis direction is defined as a direction parallel to the other direction of the axial direction of a central axis J illustrated in FIG. 1. The X-axis direction is defined as a direction parallel to a transverse direction of an electric oil pump illustrated in FIG. 1, namely as a left-right direction of FIG. 1. The Y-axis direction is defined as a direction perpendicular to both the X-axis direction and the Z-axis direction.

Further, in the following description, a positive side (a +Z side) in the Z-axis direction is referred to as a “rear side,” and a negative side (a −Z side) in the Z-axis direction is referred to as a “front side.” The rear side and the front side are merely names used for the description, and do not limit an actual position relationship or direction. Further, unless stated otherwise, the direction (the Z-axis direction) parallel to the central axis J is referred to simply as an “axial direction,” a radial direction whose center is the central axis J is referred to simply as a “radial direction,” and a circumferential direction whose center is the central axis J, namely an axial circumference of the central axis J (a θ direction), is referred to simply as a “circumferential direction.”

In the present specification, extending in the axial direction also includes extending in a direction inclined with respect to the axial direction in a range of less than 45° in addition to strictly extending in the axial direction (in the Z-axis direction). Further, in the present specification, extending in the radial direction also includes extending in a direction inclined with respect to the radial direction in a range of less than 45° in addition to strictly extending in the radial direction, namely extending in a direction perpendicular to the axial direction (the Z-axis direction).

### First Example Embodiment

### Whole Constitution

FIG. 1 is a sectional view of an electric oil pump according to a first example embodiment. As illustrated in FIG. 1, the electric oil pump 1 of the present example embodiment has a motor portion 10, a pump portion 40, and an inverter portion 70. The motor portion 10 and the pump portion 40 are disposed in the axial direction. The motor portion 10 has a shaft 11 that is disposed along the central axis J extending in the axial direction. The pump portion 40 is located on one side (the front side) of the motor portion 10 in the axial direction, is driven via the shaft 11 by the motor portion 10, and discharges oil. The inverter portion 70 is located on the other side (the rear side) of the motor portion 10 in the axial direction, and is fixed to the motor portion 10. Hereinafter, each constituent member will be described in detail.

### Motor Portion 10

As illustrated in FIG. 1, the motor portion 10 has a motor housing 13, a rotor 20, the shaft 11, and a stator 22.

The motor portion 10 is, for instance, an inner rotor type motor, in which the rotor 20 is fixed to an outer circumferential surface of the shaft 11, and the stator 22 is located outside the rotor 20 in the radial direction.

### Motor Housing 13

The motor housing 13 has a stator holding part 13a, an inverter holding part 13b, a pump body holding part 13c, and a motor fixing portion 15. The motor housing 13 is formed of a metal. The motor housing 13 has a bottomed cylindrical shape having a bottom 13d on a side adjacent to the inverter portion 70.

### Stator Holding Part 13a

The stator holding part 13a extends in the axial direction, and has a through-hole 13a1 therein. The shaft 11, the rotor 20, and the stator 22 of the motor portion 10 are disposed in the through-hole 13a1. An outer surface of the stator 22, namely an outer surface of a core back part 22a (to be described below) is fitted into an outer surface of the stator holding part 13a. Thus, the stator 22 is housed in the stator holding part 13a.

### Inverter Holding Part 13b

The inverter holding part 13b is a portion that is linked to a rear-side end 13b1 of the stator holding part 13a. In the present example embodiment, the inverter holding part 13b has the rear-side end 13b1 of the stator holding part 13a, and the bottom 13d of a disc shape which extends inward from the rear-side end 13b1 in the radial direction. A communication hole 13d1 communicating in the axial direction is provided in the central portion of the bottom 13d. The communication hole 13d1 communicates with a through-hole 71 provided in the inverter portion 70, and causes the inside of the inverter portion 70 to communicate with the inside of the motor portion 10.

The bottom 13d has a plurality of threaded holes 13d2 that are provided outside the communication hole 13d1 in the radial direction at intervals in the circumferential direction and penetrate in the axial direction. In the present example embodiment, threaded hole portions 13d3 of the bottom 13d in which the threaded holes 13d2 are provided have thicker thicknesses (wall thicknesses) in the axial direction than an outer portion 13d4 of the bottom 13d in the radial direction. This thickens the thicknesses of the threaded hole portions 13d3 in the axial direction in order to secure necessary minimum lengths of the threaded holes 13d2 in the axial direction. In the threaded hole portions 13d3, a metal plate may be burred to form tubular flange parts that protrude to one side in the axial direction, and female threaded parts may be provided on inner surfaces of the flange parts.

### Pump Body Holding Part 13c

The pump body holding part 13c has a tubular shape whose front side is open, and is continuously linked to a front-side end of the stator holding part 13a. A hole portion 13c1 extending in the axial direction is provided in the pump body holding part 13c. An inner diameter of the hole portion 13c1 has a dimension that is slightly larger than a rear-side outer diameter of the pump body 52 of the pump portion 40 (to be described below). A rear side of the pump body 52 is fitted into an inner surface of the hole portion 13c1.

An outer surface 13c2 of the pump body holding part 13c has a motor-side flange part 13c3 that protrude in the radial direction. The motor-side flange part 13c3 is disposed to face a pump-side flange part 52a provided on the pump body 52 (to be described below), and is fixed to the pump-side flange part 52a by fastening means such as bolts 42. Thus, the pump portion 40 is fixed to the motor housing 13.

### Motor Fixing Portion 15

As illustrated in FIG. 1, the motor fixing portion 15 is fixed to the pump portion 40. The motor fixing portion 15 has a fixing surface portion 15a that is disposed to face an outer surface 13e of the motor housing 13, and a protruding portion 15b that protrudes from the fixing surface portion 15a. The fixing surface portion 15a has a plate shape that is curved along the outer surface 13e of the motor housing 13. The fixing surface portion 15a has a fusion portion 15a1 on an outer circumferential edge thereof. The fusion portion 15a1 is a portion that fuses the fixing surface portion 15a to the outer surface 13e of the motor housing 13 by welding. For this reason, the fixing surface portion 15a is firmly fixed to the outer surface 13e of the motor housing 13 via the fusion portion 15a1. The fixing surface portion 15a is not limited to the case in which the fixing surface portion 15a is fixed to the outer surface 13e of the motor housing 13 by welding. The fixing surface portion 15a may be fixed to the outer surface 13e of the motor housing 13 by fastening means such as bolts.

The protruding portion 15b protrudes from one side end of the fixing surface portion 15a in the circumferential direction to the outside in the radial direction. In the present example embodiment, the protruding portion 15b has a plate shape having a pair of planar side surfaces 15b1 on both sides thereof in the circumferential direction. A hole portion 15b2 is provided on a tip side of the protruding portion 15b in a protruding direction. A bolt 16 is made to pass through the hole portion 15b2, and the protruding portion 15b is fixed to a pump fixing portion 65 that is provided adjacent to the pump portion 40. The pump fixing portion 65 will be described in detail below.

The motor fixing portion 15 is located outside a side surface of the motor housing 13, and is disposed adjacent to the inverter portion 70. In the present example embodiment, a rear-side end 15b3 of the protruding portion 15b of the motor fixing portion 15 is disposed at a position close to a front-side end of the inverter portion 70. For this reason, the motor fixing portion 15 can be disposed at a position closer to the inverter portion 70. Further, the motor fixing portion 15 is disposed adjacent to the pump fixing portion 65. In the present example embodiment, the center P of a fixing hole portion 65a of the pump fixing portion 65 is disposed on a virtual line L0 that extends in a direction perpendicular to the axial direction through the center of gravity G0 of the electric oil pump 1, and a position of the center S of the hole portion 15b2 of the protruding portion 15b of the motor fixing portion 15 is disposed closer to the motor housing 13 and the inverter portion 70 than the center P of the fixing hole portion 65a of the pump fixing portion 65. Accordingly, the motor fixing portion 15 can be fixed to the pump fixing portion 65 at a position close to the inverter portion 70. A fixed position Q is a region in which the pump fixing portion 65 is fixed to, for instance, a gearbox by a head of a bolt passed into the fixing hole portion 65a. For this reason, the fixed position Q includes a region in which the fixing hole portion 65a and the head of the bolt outside the fixing hole portion 65a in the radial direction come into contact with the pump fixing portion 65. Accordingly, the center of the fixed position Q becomes the center P.

Further, the position of the center S of the hole portion 15b2 of the protruding portion 15b of the motor fixing portion 15 may be disposed at a position closer to the inverter portion 70 than virtual lines L1, L2 and L3 that extend in directions perpendicular to the axial direction through the centers of gravity G1, G2 and G3 of any of the motor portion 10, the rotor 20, and the stator 22. The centers of gravity G1, G2 and G3 are located closer to the inverter portion 70 than the center of gravity G0. For this reason, the position of the center S of the hole portion 15b2 is disposed at the position closer to the inverter portion 70 than virtual lines L1, L2 and L3 that extend in the directions perpendicular to the axial direction through the centers of gravity G1, G2 and G3, and thereby the motor fixing portion 15 can be disposed at a position closer to the inverter portion 70.

When the motor fixing portion 15 is fixed to the pump fixing portion 65, the motor fixing portion 15 may be fastened and fixed to the pump fixing portion 65 by disposing an elastic body, which can absorb vibrations, between the motor fixing portion 15 and a fixing projection part 67 of the pump fixing portion 65.

### Rotor 20

The rotor 20 has a rotor core 20a and a rotor magnet 20b. The rotor core 20a surrounds the shaft 11 along the axial circumference (in the θ direction), and is fixed to the shaft 11. The rotor magnet 20b is fixed to an outer surface of the rotor core 20a which extends along the axial circumference (in the θ direction). The rotor core 20a and the rotor magnet 20b are rotated along with the shaft 11. The rotor 20 may be an embedded magnet type in which permanent magnets are embedded in the rotor 20. In comparison with a surface magnet type in which permanent magnets are provided on a surface of the rotor 20, the embedded magnet type rotor 20 can reduce a fear that magnets will be peeled off by a centrifugal force, and positively use reluctance torque.

### Stator 22

The stator 22 surrounds the rotor 20 along the axial circumference (in the θ direction), and rotates the rotor 20 around the central axis J. The stator 22 has a core back part 22a, tooth parts 22c, coils 22b, and insulators (bobbins) 22d.

A shape of the core back part 22a is a cylindrical shape concentric with the shaft 11. The tooth parts 22c extend from an inner surface of the core back part 22a toward the shaft 11. The tooth parts 22c are numerously provided, and are disposed in a circumferential direction of the inner surface of the core back part 22a at equal intervals. The coils 22b are provided around the insulators (the bobbins) 22d, and conductive wires 22e are wound on them. The insulators (the bobbins) 22d are mounted on the respective tooth parts 22c.

### Shaft 11

As illustrated in FIG. 1, the shaft 11 extends along the central axis J, and passes through the motor portion 10. The front side (the −Z side) of the shaft 11 protrudes from the motor portion 10, and extends into the pump portion 40. The rear side (the +Z side) of the shaft 11 protrudes from the rotor 20 to become a free end. For this reason, the rotor 20 is brought into a cantilever support state in which the front side of the shaft 11 is supported by a sliding bearing 45 (to be described below).

### Inverter Portion 70

The inverter portion 70 has an inverter housing 73 having a bottomed container shape which has a circuit board housing portion 73a whose rear side is open and which is recessed on the front side and extends in the X-axis direction, and a cover part 90.

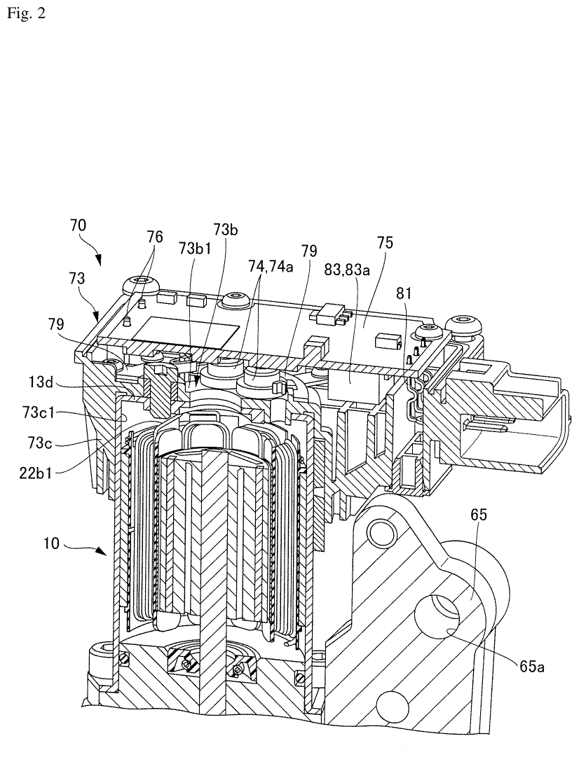

A rear-side opening of the circuit board housing portion 73a is covered by the cover part 90. A circuit board 75, connector-side terminals 76, bus bars 79 (see FIG. 2), a terminal part 81, etc. are housed in the circuit board housing portion 73a.

The connector-side terminals 76 are disposed on the left side within the circuit board housing portion 73a in the X-axis direction, one end sides thereof are electrically connected to coil ends 22b1 of the motor portion 10 via the bus bars 79, and the other end sides thereof are electrically connected to the circuit board 75. The terminal part 81 is disposed on the right side within the circuit board housing portion 73a in the X-axis direction, one end side thereof is electrically connected to an external connector (not illustrated), and the other end side thereof is electrically connected to the circuit board 75.

The circuit board 75 outputs a motor output signal. The circuit board 75 is disposed on the rear side of the circuit board housing portion 73a, and extends in a direction across the axial direction. In the present example embodiment, the circuit board extends in the X-axis direction perpendicular to the axial direction. Printed wiring (not illustrated) is provided on a side surface (a front side surface 75a) of the front side of the circuit board 75. Further, a plurality of electronic components are mounted on the front side surface 75a of the circuit board 75. In the illustrated example embodiment, an electronic component 83 (e.g., a capacitor 83a, a choke coil 83b, or the like) whose leads are electrically connected to the circuit board 75 is mounted. Further, a copper inlay board is used as the circuit board 75, and thus heat generated by heater elements (not illustrated) can be radiated via the cover part.

FIG. 2 is a sectional view illustrating the inverter housing 73 having an inverter housing fixing portion 73b according to the present example embodiment when viewed from a diagonal front side. As illustrated in FIG. 2, the inverter housing fixing portion 73b fixed to the bottom 13d of the motor housing 13 is provided on the front side of the inverter housing 73. The inverter housing fixing portion 73b has a plate-shaped fixing surface portion 73b1 that extends along the bottom 13d. The fixing surface portion 73b1 is fastened and fixed to the bottom 13d via fixing members 74 in a state in which it is superposed on the bottom 13d. In the present example embodiment, the inverter housing fixing portion 73b has a disc shape when viewed in the axial direction. Further, the fixing members 74 are bolts 74a. The bolts 74a are numerously disposed at intervals in the circumferential direction outside the through-hole 71 above the fixing surface portion 73b1 in the radial direction.

The electronic component 83 is disposed at a position at which it overlaps the inverter housing fixing portion 73b in a direction perpendicular to the axial direction. In the present example embodiment, the capacitor 83a and the choke coil 83b are disposed at positions at which they overlap the bolts 74a of the inverter housing fixing portion 73b in the X-axis direction perpendicular to the axial direction. For this reason, an axial distance between the inverter housing fixing portion 73b and the capacitor 83a and an axial distance between the inverter housing fixing portion 73b and the choke coil 83b can be shortened.

Further, the electronic component 83 is disposed outside the fixing surface portion 73b1 of the inverter housing fixing portion 73b in the radial direction out of a surface portion of the circuit board 75 which is directed to the vicinity of the motor portion 10, and is directed to the vicinity of the pump portion 40. In the present example embodiment, the capacitor 83a is disposed outside the fixing surface portion 73b1 of the inverter housing fixing portion 73b in the radial direction out of the front side surface 75a of the circuit board 75 which is directed to the vicinity of the motor portion 10, and is directed to the vicinity of the pump portion 40. For this reason, the position of the capacitor 83a in the axial direction can be disposed further forward, and the axial distance between the inverter housing fixing portion 73b and the capacitor 83a can be further shortened.

As illustrated in FIG. 2, the plurality of bus bars 79 are disposed on the fixing surface portion 73b1 of the inverter housing fixing portion 73b. In the present example embodiment, three bus bars 79 are disposed at intervals in the circumferential direction. The connector-side terminal 76 and the coil end 22b1 are connected to each of the three bus bars 79. Since the plurality of bus bar 79 are disposed on the fixing surface portion 73b1, the coil ends 22b1 can be electrically connected to the circuit board 75 without performing complicated wiring.

The inverter housing 73 has a wall portion 73c that extends from a circumferential edge of the inverter housing fixing portion 73b to the front side. A fitting hole portion 73c1 into which the rear side of the motor housing 13 is fitted is provided inside the wall part 73c. For this reason, in the state in which the rear side of the motor housing 13 is fitted into the fitting hole portion 73c1, the inverter housing fixing portion 73b is fixed to the bottom 13d of the motor housing 13, and thereby the inverter portion 70 can be fixed to the motor housing 13 in a state in which the inverter portion 70 maintains a prescribed posture with respect to the motor housing 13.

### Pump Portion 40

As illustrated in FIG. 1, the pump portion 40 is located on one side of the motor portion 10 in the axial direction, and particularly on the front side (the −Z side). The pump portion 40 is driven via the shaft 11 by the motor portion 10. The pump portion 40 has a pump rotor 47 and a pump housing 51. The pump housing 51 has a pump body 52 and a pump cover 57. Hereinafter, each component will be described in detail.

### Pump Body 52

The pump body 52 is fixed inside the front side (the −Z side) of the motor housing 13 on the front side (the −Z side) of the motor portion 10. The pump body 52 has a recess portion 54 that is recessed from a surface of the rear side (the +Z side) to the front side (the −Z side). A seal member 59 is housed in the recess portion 54. An annular recess portion 60 recessed inward in the radial direction is provided in an outer surface 52b on the rear side of the pump body 52. A seal member 61 (e.g., an O-ring) is inserted into the recess portion 60.

The pump body 52 has a through-hole 55 penetrated along the central axis J. The through-hole 55 is configured such that both ends thereof are open in the axial direction such that the shaft 11 passes through the ends, an opening of the rear side (the +Z side) opens to the recess portion 54, and an opening of the front side (the −Z side) opens to a front-side end of the pump body 52. The through-hole 55 functions as the sliding bearing 45 that rotatably supports the shaft 11.

The pump-side flange parts 52a are provided on an outer end of the pump body 52 in the radial direction. The pump-side flange parts 52a are numerously provided at intervals in the circumferential direction.

### Pump Cover 57

As illustrated in FIG. 1, the pump cover 57 has a pump cover main body part 57a that is mounted on one side of the pump body 52 in the axial direction, and a pump cover arm part 57b that extends from one-side end of the pump cover main body part 57a in the radial direction toward the vicinity of the motor portion 10. The pump cover main body part 57a has a housing portion 53 that houses the pump rotor 47 and has a side surface and a bottom surface located on the front side (the −Z side) of the motor portion 10. The housing portion 53 opens to the rear side (the +Z side), and is recessed to the front side (the −Z side). When viewed in the axial direction, a shape of the housing portion 53 is a circular shape.

The pump cover main body part 57a covers the pump body from the front side (the −Z side), and thereby the housing portion 53 is provided between the pump cover main body part 57a and the pump body 52.

Pump cover-side flange parts 57a1 are provided on an outer end of the pump cover main body part 57a in the radial direction. The pump cover-side flange parts 57a1 are numerously provided at intervals in the circumferential direction. Female threads to which bolts 42 can be screwed are provided on the pump cover-side flange parts 57a1.

The motor-side flange parts 13c3 and the pump-side flange parts 52a are disposed to be superposed on the pump cover-side flange parts 57a1, and the bolts 42 inserted through the motor-side flange parts 13c3 and the pump-side flange parts 52a are fastened to female threads provided on the pump cover-side flange parts 57a1. Thereby, the motor portion 10 can be fixed to the pump portion 40.

The pump cover arm part 57b extends from an outer end of one side of the pump cover main body part 57a in the radial direction to the rear side of the motor portion 10 along an outer surface 13e of the motor housing 13. The pump cover arm part 57b is formed in a rectangular parallelepiped shape, and is reinforced in rigidity. The pump fixing portion 65 is fixed to a rear-side end of the pump cover arm part 57b. In the present example embodiment, the pump fixing portion 65 is fixed to, for instance, the gearbox. The pump fixing portion 65 has a box shape, and has a fixing hole portion 65a penetrated in the Y-axis direction. Fastening means such as bolts are inserted into the fixing hole portion 65a, and the pump fixing portion 65 is firmly fixed to a fixing target such as a gearbox.

The fixing projection part 67 protruding to the vicinity of the motor portion 10 is provided on a rear-side end of the pump fixing portion 65. A female threaded part is provided on a tip portion of the fixing projection part 67 in a protruding direction. The bolt inserted into the hole portion 15b2 of the protruding portion 15b is screwed to the female threaded part of the fixing projection part 67, and thereby the motor fixing portion 15 is fixed to the fixing projection part 67.

For this reason, the motor portion 10 is firmly fixed to the pump fixing portion 65.

In the present example embodiment, the example in which the housing portion 53 in which the pump rotor 47 is housed is provided on the pump cover 57 is given, but the present disclosure is not limited thereto. The housing portion 53 may be provided on the pump body 52.

### Pump Rotor 47

The pump rotor 47 is mounted on the shaft 11. To be more specific, the pump rotor 47 is mounted on the front side (the −Z side) of the shaft 11. The pump rotor 47 has an inner rotor 47a that is mounted on the shaft 11, and an outer rotor 47b that surrounds the outside of the inner rotor 47a in the radial direction. The inner rotor 47a has a toric shape. The inner rotor 47a is a gear having teeth on an outer surface thereof in the radial direction.

The inner rotor 47a is fixed to the shaft 11. To be more specific, an end of the shaft 11 on the front side (the −Z side) of the shaft 11 is forcibly fitted into the inner rotor 47a. The inner rotor 47a is rotated around the axis (in the θ direction) along with the shaft 11. The outer rotor 47b has a toric shape that surrounds the outside of the inner rotor 47a in the radial direction. The outer rotor 47b is a gear having teeth on an inner surface thereof in the radial direction.

The inner rotor 47a and the outer rotor 47b are engaged with each other. The inner rotor 47a is rotated, and thereby the outer rotor 47b is rotated. That is, the pump rotor 47 is rotated by rotation of the shaft 11. In other words, the motor portion 10 and the pump portion 40 have the same rotary shaft. Thus, the electric oil pump 1 can be prevented from being enlarged in the axial direction.

Further, the inner rotor 47a and the outer rotor 47b are rotated, and thereby a volume between engaged portions of the inner rotor 47a and the outer rotor 47b is changed. A region in which the volume is reduced becomes a pressure region, and a region in which the volume is increased becomes a suction region. A suction port is disposed on the rear side (the +Z side) of the suction region of the pump rotor 47. Further, a discharge port is disposed on the rear side (the +Z side) of the pressure region of the pump rotor 47. Here, oil sucked from a suction inlet 57c provided in the pump cover 57 into the housing portion 53 is stored in the volume portion between the inner rotor 47a and the outer rotor 47b, and is sent to the pressure region. Afterward, the oil is discharged from a discharge outlet 57d provided in the pump cover 57 through the discharge port.

### Operation and Effects of the Electric Oil Pump 1

Next, an operation and effects of the electric oil pump will be described. As illustrated in FIG. 1, if the motor portion 10 of the electric oil pump 1 is driven, the shaft 11 of the motor portion 10 is rotated, the outer rotor 47b is also rotated along with rotation of the inner rotor 47a of the pump rotor 47. If the pump rotor 47 is rotated, oil sucked from the suction inlet 57c of the pump portion 40 moves into the housing portion 53 of the pump portion 40, and is discharged from the discharge outlet 57d through the discharge port.

(1) Here, the electronic component 83 mounted on the circuit board 75 of the electric oil pump 1 according to the present example embodiment is disposed at a position at which it overlaps the inverter housing fixing portion 73b in a direction perpendicular to the axial direction. The electronic component 83 is considered to be in a state in which it is supported in a cantilever form using the inverter housing fixing portion 73b as a fixing point. For this reason, when the circuit board 75 is viewed in the direction perpendicular to the axial direction, moment corresponding to a distance between the electronic component 83 and the inverter housing fixing portion 73b in the axial direction acts on the electronic component 83. If vibrations generated from, for instance, an engine is transmitted to the motor portion 10 via, for instance, a gearbox, the vibrations are propagated to the electronic component 83 via the inverter housing 73, and generate repeated stress in the electronic component 83. Therefore, there occurs a fear that a portion (e.g., a rim of the capacitor 83a) at which the electronic component 83 is fixed to the circuit board 75 is reduced in life span and is subjected to damage, fracture, and so on. Therefore, in the present disclosure, since the electronic component 83 is disposed at a position at which it overlaps the inverter housing fixing portion 73b in the direction perpendicular to the axial direction, an increase in the moment acting on the electronic component 83 can be curbed. Accordingly, damage to the electronic component 83 can be curbed.

(2) Further, the motor housing 13 has the planar bottom 13d at the core-side end thereof, and the inverter housing fixing portion 73b has the fixing member 74 that is fastened and fixed to the bottom 13d. For this reason, the inverter housing fixing portion 73b can be firmly fixed to the bottom 13d of the motor housing 13.

(3) Further, the inverter housing fixing portion 73b has the plate-shaped fixing surface portion 73b1 that extends along the bottom 13d, and the fixing surface portion 73b1 is fastened and fixed to the bottom 13d via the fixing member 74 in the state superposed on the bottom 13d. In the state in which the fixing surface portion 73b1 is superposed on the bottom 13d, the fixing surface portion 73b1 is brought into a surface contact with the bottom 13d. For this reason, the fixing member 74 can be fixed to the bottom 13d in a wide region, and fixing strength of the fixing member 74 to the bottom 13d can be further increased.

(4) Further, the electronic component 83 is disposed outside the fixing surface portion 73b1 of the inverter housing fixing portion 73b in the radial direction out of the surface portion of the circuit board 75 which is directed to the vicinity of the motor portion 10, and is directed to the vicinity of the pump portion 40. If the electronic component 83 disposed on the surface portion of the circuit board 75 which is directed to the vicinity of the motor portion 10 is disposed inside the fixing surface portion 73b1 in the radial direction, there occurs a fear that the electronic component 83 comes into contact with, for instance, the bolts 74a of the fixing member 74. For this reason, if the electronic component 83 is disposed apart from, for instance, the bolts 74a to the rear side, a distance between the electronic component 83 and the pump fixing portion 65 in the Z-axis direction increases, and the increase in the moment acting on the electronic component 83 is caused. Therefore, the electronic component 83 is disposed outside the fixing surface portion 73b1 of the inverter housing fixing portion 73b in the radial direction, and is directed to the vicinity of the pump portion 40. Thereby, even if the electronic component 83 is disposed on the front side, there occurs no fear that the electronic component 83 comes into contact with the bolts 74a. Therefore, the distance between the electronic component 83 and the pump fixing portion 65 in the Z-axis direction is shortened, and the increase in the moment acting on the electronic component 83 can be further curbed.

(5) Further, the inverter housing 73 has the fitting hole portion 73c1 which extends from a circumferential edge of the fixing surface portion 73b1 to one side in the axial direction, and into which the outer surface 13e of the motor housing 13 of the motor portion 10 is fitted. For this reason, the inverter housing 73 adjacent to the motor portion 10 can be fixed in close contact with the motor housing 13. Therefore, the inverter portion 70 can be more firmly fixed to the motor portion 10.

### Second Example Embodiment

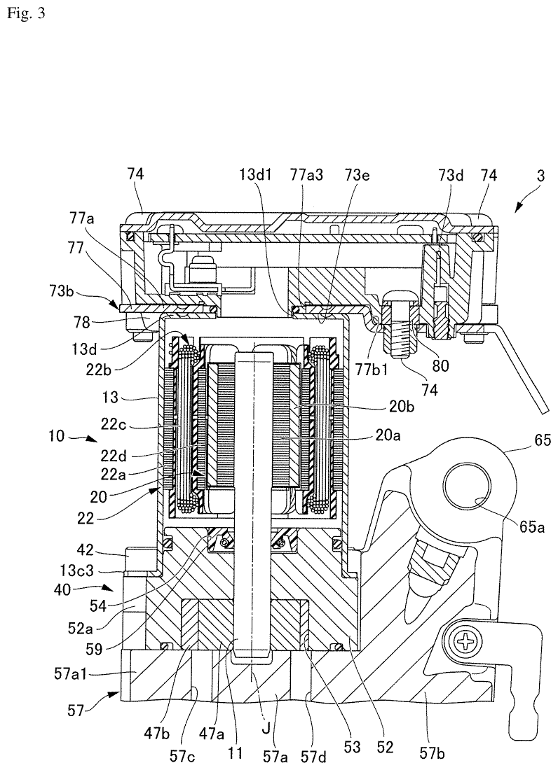

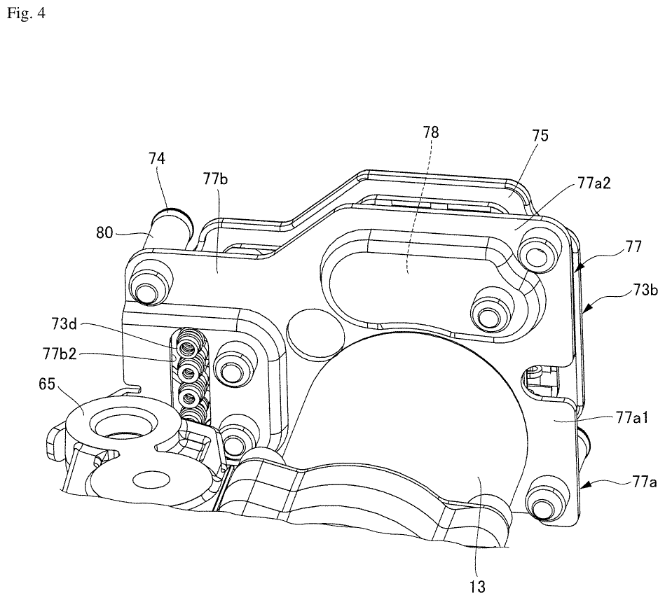

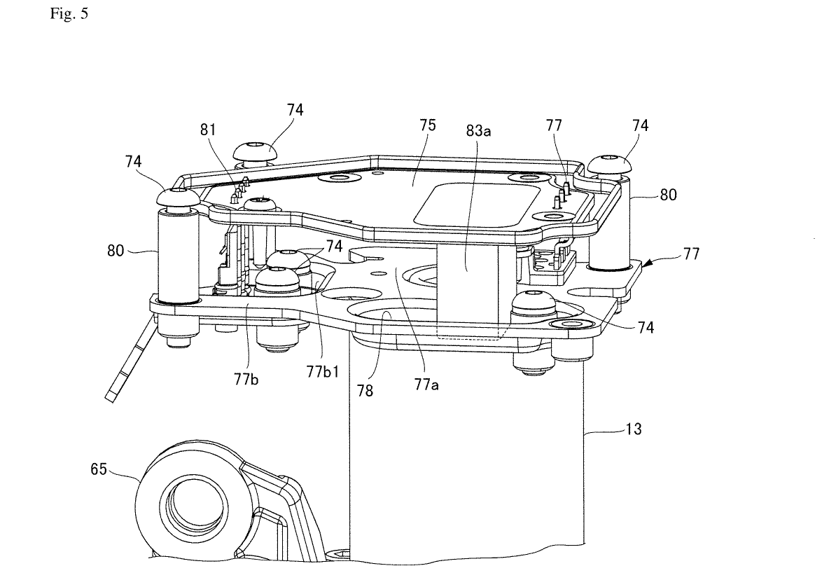

FIG. 3 is a sectional view of an electric oil pump 3 according to a second example embodiment. FIG. 4 is a perspective view of a fixing plate portion 77 when the electric oil pump 3 according to the second example embodiment is viewed from a diagonal front side. FIG. 5 is an internal structure view of an inverter housing 73 for illustrating a position relationship of a capacitor 83a mounted on a circuit board 75 according to the second example embodiment to an electronic component disposing recess portion 78. In the second example embodiment, only a difference from the aforementioned first example embodiment will be described, and the same mode portions as in the first example embodiment are given the same reference signs, and description thereof is omitted.

As illustrated in FIGS. 3, 4 and 5, an inverter housing fixing portion 73b has a fixing plate portion 77 that is formed of a metal and extends along a front-side bottom face of an inverter housing 73. The fixing plate portion 77 has a similar shape that is larger than the front-side bottom face of the inverter housing 73. The fixing plate portion 77 has a first fixing plate portion 77a having a fixing surface portion 73b1, and a second fixing plate portion 77b that extends from a plus-side end of the first fixing plate portion 77a in the X-axis direction.

The first fixing plate portion 77a has a fixing main body part 77a1 that is fixed to a bottom 13d of a motor housing 13, and an extension part 77a2 that extends a plus-side end of the fixing main body part 77a1 in the Y-axis direction to the plus side in the Y-axis direction. A hole portion 77a3, which communicates with a communication hole 13d1 opening to the bottom 13d of the motor housing 13, is provided in the center of the fixing main body part 77a1. The fixing main body part 77a1 is placed on the planar bottom 13d of the motor housing 13 in the state in which the hole portion 77a3 communicates with the communication hole 13d1, and is fixed to the bottom 13d by welding.

An electronic component disposing recess portion 78, a rear side of which is open and which is recessed to a front side thereof, is provided on the extension part 77a2. The electronic component disposing recess portion 78 is located outside the motor housing 13 in the radial direction. The electronic component disposing recess portion 78 has an oval shape that has a prescribed width in the Y-axis direction and extends in the X-axis direction. The prescribed width of the electronic component disposing recess portion 78 has a size in which a capacitor 83a and a choke coil 83b, whose sizes are relatively large among electronic components 83, can be inserted.

The second fixing plate portion 77b has an external terminal mounting recess portion 77b1 recessed from a rear side thereof to a front side thereof. In the external terminal mounting recess portion 77b1, the rear side thereof and a plus side thereof in the X-axis direction are open. A hole portion 77b2, which extends in the Y-axis direction, is provided in the middle of the external terminal mounting recess portion 77b1. The hole portion 77b2 exposes a front-side end of an external terminal receiving part 73d provided on the inverter housing 73. The fixing plate portion 77 has a plate shape, but rigidity thereof is reinforced because it has the electronic component disposing recess portion 78 and the external terminal mounting recess portion 77b1.

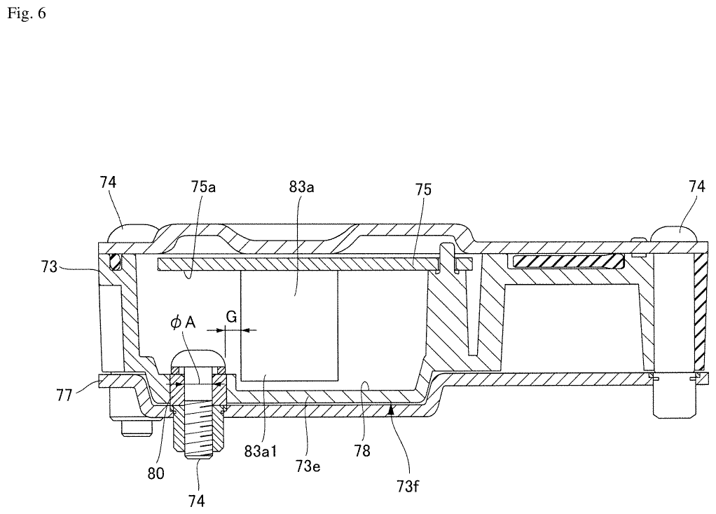

FIG. 6 is a sectional view of the inverter housing 73 having the electronic component disposing recess portion 78 according to the second example embodiment. The fixing plate portion 77 is fixed to the inverter housing 73 via fixing members 74. In the illustrated example embodiment, in a state in which the first fixing plate portion 77a of the fixing plate portion 77 is in contact with a front-side bottom 73e of the inverter housing 73, the fixing plate portion 77 is fastened and fixed between the electronic component disposing recess portion 78 and the front-side bottom 73e (see FIG. 6) of the inverter housing 73 and between the external terminal mounting recess portion 77b1 and the front-side bottom 73e of the inverter housing 73 via the fixing member 74. Further, the fixing plate portion 77 is fixed to the inverter housing 73 via the fixing member 74 inserted through the cover part 90 and the inverter housing 73 at four corners of the fixing plate portion 77.

Since the inverter housing 73 is formed of a resin, there is a fear that the inverter housing 73 is damaged if the fixing member 74 is directly fastened to the inverter housing 73. For this reason, the fixing member 74 is inserted through a collar 80 formed of a metal, and fixes the fixing plate portion 77 to the inverter housing 73 via the collar 80.

Further, the fixing main body part 77a1 of the fixing plate portion 77 is fixed to the bottom 13d of the motor housing 13 by welding (e.g., spot welding). The fixture of the fixing main body part 77a1 to the bottom 13d of the motor housing 13 is not limited to welding. The fixing main body part 77a1 may be fixed to the bottom 13d of the motor housing 13 by fixing members such as bolts.

Electronic components 83 are mounted on the front side surface 75a of the circuit board 75. In the present example embodiment, as illustrated in FIG. 6, the capacitor 83a having a large size among the electronic components 83 is mounted on a front side surface 75a at a position opposite to the electronic component disposing recess portion 78. A front-side end 83a1 of the capacitor 83a is disposed in the electronic component disposing recess portion 78. For this reason, the capacitor 83a is disposed at a position at which it overlaps the fixing plate portion 77 of the inverter housing fixing portion 73b in a direction perpendicular to the axial direction. Further, the front-side end 83a1 of the capacitor 83a is disposed within an axial region in which the fixing member 74 that fastens a bottom 73f of the inverter housing 73 protrudes from the bottom 73f to the rear side, and is disposed adjacent to the fixing member 74 with a gap G smaller than a shaft diameter φA of the fixing member 74. For this reason, a distance between the capacitor 83a disposed in the electronic component disposing recess portion 78 and the fixing member 74 can be further shortened.

In the second example embodiment, the case where the capacitor 83a is disposed in the electronic component disposing recess portion 78 is illustrated, but the present disclosure is not limited thereto. The choke coil 83b may be disposed in the electronic component disposing recess portion 78 along with the capacitor 83a, and the choke coil 83b may be disposed in the electronic component disposing recess portion 78.

### Operation and Effects of the Electric Oil Pump 3 According to the Second Example Embodiment

(1) Here, the electronic component 83 (the capacitor 83a) mounted on the circuit board 75 of the electric oil pump 3 of the second example embodiment is disposed at the position at which it overlaps the fixing plate portion 77, which is the inverter housing fixing portion 73b, in the direction perpendicular to the axial direction. For this reason, when the circuit board 75 is viewed in the direction perpendicular to the axial direction, the distance between the electronic component 83 and the inverter housing fixing portion 73b (the fixing plate portion 77) in the axial direction can be further reduced. For this reason, an increase in moment acting on the electronic component 83 can be curbed, and damage to the electronic component 83 can be curbed.

(2) Further, the inverter housing fixing portion 73b has the fixing plate portion 77 that is formed of a metal and extends along the bottom face on one side of the inverter housing 73 in the axial direction. The fixing plate portion 77 is fixed to the inverter housing 73 via the fixing member 74, and is fixed to the motor housing 13 by welding. For this reason, the inverter housing 73 can be firmly fixed to the motor portion 10 via the fixing plate portion 77. Accordingly, an increase in propagation of vibrations from the motor portion 10 to the vicinity of the inverter portion 70 can be curbed.

(3) Further, the fixing plate portion 77 has the electronic component disposing recess portion 78 which is recessed to one side thereof in the axial direction and in which at least a part of the electronic component 83 mounted on the circuit board 75 is disposed. For this reason, if the electronic component 83 is disposed in the electronic component disposing recess portion 78, the distance between the electronic component 83 and the fixing plate portion 77 in the axial direction can be further shortened. Accordingly, the increase in the moment acting on the electronic component 83 can be further curbed.

(4) Further, the electronic component disposing recess portion 78 has the fixing member 74 that fastens the bottom (the front-side bottom 73e) of the inverter housing 73 to the fixing plate portion 77, and the at least part of the electronic component 83 is disposed within the axial region in which the fixing member 74 that fastens the bottom 73f protrudes from the bottom 73f to the other side in the axial direction, and is disposed adjacent to the fixing member 74 with the gap G smaller than the shaft diameter φA of the fixing member 74. For this reason, the distance between the electronic component 83 disposed in the electronic component disposing recess portion 78 and the fixing plate portion 77 can be further shortened. Accordingly, the increase in the moment acting on the electronic component 83 can be further curbed.

(5) Further, the electronic component 83 is at least one of the capacitor 83a and the choke coil 83b. The capacitor 83a and the choke coil 83b have a large size and heavy weight compared to other electronic components (e.g., a semiconductor element and a resistor). For this reason, the electronic component 83 is used as at least one of the capacitor 83a and the choke coil 83b, and thereby the electric oil pump 3 capable of preventing a fear that the capacitor 83a and the choke coil 83b are damaged by vibrations by curbing the increase in the moment acting on the capacitor 83a and the choke coil 83b can be provided.

Although preferred example embodiments of the present disclosure have been described, the present disclosure is not limited to these example embodiments. The present disclosure can be variously modified and changed without departing from the spirit and scope of the present disclosure. These example embodiments and modifications are included in the scope and spirit of the present disclosure, as well as in the disclosure set forth in the claims and equivalents thereof.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-10. (canceled)

11. An electric oil pump comprising:
a motor including a shaft with a central axis extending in an axial direction;
a pump located on one side of the motor in the axial direction and driven via the shaft by the motor to discharge oil; and
an inverter located on another side of the motor in the axial direction and fixed to the motor; wherein
the motor includes:
a rotor that is fixed on a side of the shaft in the axial direction;
a stator that is located outside the rotor in a radial direction; and
a motor housing that houses the rotor and the stator;
the pump includes:
a pump rotor that is mounted on the shaft protruding from the motor to one side in the axial direction; and
a pump housing that includes a housing in which the pump rotor is housed;
the inverter includes:
an inverter housing that includes a circuit board housing in which a circuit board is housed; and
an inverter housing fixing that fixes the inverter housing to an end of the motor housing in the axial direction;
the pump includes a pump fixing connector to be fixed;
the circuit board includes an electronic component mounted on the circuit board;
the electronic component is mounted on the circuit board adjacent to the motor; and
the electronic component overlaps the inverter housing fixing connector in a direction perpendicular or substantially perpendicular to the axial direction.

12. The electric oil pump according to claim 11, wherein
the motor housing includes a planar bottom at the end thereof in the axial direction; and
the inverter housing fixing connector includes fixing members that are fastened and fixed to the bottom.

13. The electric oil pump according to claim 12, wherein
the inverter housing fixing connector includes a plate-shaped surface extending along the bottom; and
the plate-shaped fixing surface is fastened and fixed to the bottom via the fixing members so as to be superposed on the bottom.

14. The electric oil pump according to claim 13, wherein the electronic component is outside the plate-shaped fixing surface in the radial direction out of a surface portion directed to a vicinity of the motor of the circuit board, and is directed to a vicinity of the pump.

15. The electric oil pump according to claim 14, wherein
the fixing members are positioned on the plate-shaped fixing surface at intervals in a circumferential direction; and
the electronic component overlaps the fixing members protruding onto the plate-shaped fixing surface in the direction perpendicular or substantially perpendicular to the axial direction.

16. The electric oil pump according to claim 13, wherein the inverter housing includes a fitting hole that extends from a circumferential edge of the plate-shaped fixing surface to one side thereof in the axial direction and is fitted into an outer surface of the motor housing of the motor.

17. The electric oil pump according to claim 11, wherein
the inverter housing fixing connector includes a fixing plate that is made of a metal and extends along a one-side bottom surface of the inverter housing in the axial direction; and
the fixing plate is fixed to the inverter housing via the fixing members, and is fixed to the motor housing by welding.

18. The electric oil pump according to claim 17, wherein the fixing plate includes an electronic component disposing recess which is recessed to one side thereof in the axial direction and in which at least a portion of the electronic component mounted on the circuit board is provided.

19. The electric oil pump according to claim 18, wherein
the electronic component disposing recess includes the fixing members that fasten the bottom of the inverter housing to the fixing plate; and
the electronic component is configured such that the at least a portion thereof is within an axial region in which the fixing member that fastens the bottom protrudes from the bottom to a side in the axial direction, and is adjacent to the fixing member with a gap smaller than a shaft diameter of the fixing member.

20. The electric oil pump according to claim 11, wherein the electronic component is at least one of a capacitor and a choke coil.

21. The electric oil pump according to claim 12, wherein the electronic component is at least one of a capacitor and a choke coil.

22. The electric oil pump according to claim 13, wherein the electronic component is at least one of a capacitor and a choke coil.

23. The electric oil pump according to claim 14, wherein the electronic component is at least one of a capacitor and a choke coil.

24. The electric oil pump according to claim 15, wherein the electronic component is at least one of a capacitor and a choke coil.

25. The electric oil pump according to claim 16, wherein the electronic component is at least one of a capacitor and a choke coil.

26. The electric oil pump according to claim 17, wherein the electronic component is at least one of a capacitor and a choke coil.

27. The electric oil pump according to claim 18, wherein the electronic component is at least one of a capacitor and a choke coil.

28. The electric oil pump according to claim 19, wherein the electronic component is at least one of a capacitor and a choke coil.
